(19) United States
(12) Patent Application Publication
(10) Pub. No.: US 2007/0043590 A1
(43) Pub. Date: Feb. 22, 2007

(54) Method and System of Coordinating Communication and Quality Control in Home Care

(75) Inventor: Philip Jinn-Hwan Lee, San Francisco, CA (US)

Correspondence Address: GREY TRENDS LLC, 550 27TH STREET, APT 305, SAN FRANCISCO, CA, 94131, US

(73) Assignee: GREY TRENDS, LLC, San Francisco, CA (US)

(21) Appl. No.: 11/161,879

(22) Filed: Aug. 19, 2005

(51) Int. Cl. G06Q 10/00

(52) U.S. Cl. 705/2

(57) ABSTRACT

A method and system for managing and improving the quality of home care and home health care service through a combination of coordinated communication and performance based compensation. The system includes a database residing on a server for storing a plurality of forms and report templates. The system also includes an online interface to provide simple, easy access to the database using a remote client computer. The user inputs data into the database using the forms on the interface and views the data in the reports that the system outputs after processing and repackaging the inputted data. Incentives are provided for caregivers to perform well by using the caregiver performance scores that are inputted into the database to calculate merit-based compensation.

### TECHNICAL FIELD OF INVENTION

This invention relates to a new method and system for managing home care and home health care services. Specifically the invention includes using a communications network-based computerized system to improve the quality of home care by facilitating coordination among those concerned with the care of the patient and by linking caregiver compensation to performance ratings.

### BACKGROUND OF THE INVENTION

With roots in 19^{th} century visiting nurses' associations, professional home care dominated the health care scene until the late 1920's, when it became subordinate to the hospital-based system. However, with rising hospital costs and the rapid growth of the elderly population, home care has since developed into a cost effective alternative to institutionalized care. An additional advantage of home care is for patients to remain in the familiar and comfortable environment of one's own home.

There are problems in any industry; two problems in the home care service industry are: 1) communication remains largely uncoordinated among the healthcare professionals (doctors & social workers), clients' families, caregivers (persons who attend to the client), and company administrators, and 2) there are no effective incentives for caregivers to perform well in a particular shift; they are usually paid without any distinction as to whether the quality of care during a particular shift was good or bad. As used herein, “shift” indicates a scheduled period of caregiving or work.

In industries where transactions take place directly between buyers and sellers, there is an efficient interchange as buyers are users. In the home care industry, however, these transactions can be inefficient as multiple parties are involved in caregiving. For example, a typical transaction would start with the caregiver providing services to a client. Then the client or client's family pays the caregiver's company—not the caregiver directly—for services rendered. Later, the company provides compensation to the caregiver.

This indirect transaction creates many problems for clients, client families, caregivers, and caregiving companies. Of the many problems, one is that information is not being efficiently relayed among the multiple parties, many of whom are removed from the situation of caregiving. Another separate problem is that caregivers, working remotely in the client's home, are not easily observable—and therefore, difficult to evaluate and manage.

An approach, although less intuitive, would be to address many issues together in one integrated solution. An interdependent system may provide a cost-efficient and impactful solution to a select number of problems in the home care industry.

### SUMMARY

In one aspect, the invention is directed to a method for managing home care services by using a client/server system based on a communications network. The communications network can either be a private network, a public network, or a combination of both. The method includes storing in the system one or more variables to create forms and report templates. In this embodiment, these forms and report templates are related to patient condition, caregiver performance, and management operations. The method also includes storing in a database of the system one or more variables to identify system users, which may include user identification (e.g. name, log-in id, and email), password, and user type. The method also includes storing in the database, through the use of forms, a plurality of variables describing patients' medical background, medication history, and care information. The method also includes receiving in the system user input, including caregiver performance scores and observations of patient condition, using the forms. The computer system is used to manipulate and repackage the scores into reports to provide an analysis of the quality of home care services provided by a certain caregiver. The scores are used to determine compensation for home care services. In another aspect, the scores may be used to implement improvements with respect to specific home care service activities. Also, the scores may be used to determine whether or not to continue home care services with the specific caregiver being evaluated. The system is also used to manipulate and repackage observations of patient condition as reports in such a fashion so that users of the system can easily see trends and alerts. The system is also used to send email notifications to other users when specified to notify concerned parties of relevant changes in a client's health condition. Such changes may include a sudden rise in blood pressure, a drop in weight, and skin ruptures. The method also includes viewing the reports to be kept up to date on the current status of the patients and to determine what further improvements need to be made in the home care service.

The invention is further directed in another aspect to a system for managing home care services. The system is preferably HIPAA-compliant to ensure an appropriate level of privacy and data integrity. The system is also, preferably, a client/server based system where clients, such as caregivers, client families, company management, doctors, and other healthcare professionals can access a central repository of relevant information made easy through, for example, Internet-based access. A particularly effective aspect of the invention is that the system, where appropriate, can notify involved parties of the any changes in the home care of patients and also when reports or surveys need to be filled out. The system includes a first memory storing a plurality of variables describing patients' medical backgrounds, medication histories, and care information. The system preferably receives user input through online forms templates. The computer system further includes receiving actual caregiver performance scores for a selected subset of variables and also processing the actual performance criteria scores and repackaging the scores to reflect the quality of home care service provided by a particular caregiver. The computer system includes using the scores in a process of calculating compensation for caregivers. The data gathered about various home care activities and their successfulness can be catalogued. The data can be repackaged and manipulated as needed. The system can then initiate the display of the repackaged data as reports.

Advantages of the invention will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DRAWINGS—FIGURES

FIGS. 1A and 1B shows two different block diagram views of a client/server embodiment of the system of the invention.

FIG. 2 shows a flowchart of the performance based compensation aspect of the system.

FIG. 3 shows a block diagram of the menu options available a Client's Family Class user's point of view.

FIG. 4 shows a block diagram of the system in operation from an Healthcare Professional Class user's point of view.

FIG. 5 shows a block diagram of the menu options available from a Caregiver Class user's point of view.

FIG. 6 shows a block diagram of the system in operation from an Administrator Class user's point of view.

### DETAILED DESCRIPTION—PREFERRED EMBODIMENT

The present invention may be understood more readily by reference to the following detailed description of preferred embodiments of the invention.

Before the present methods and apparatuses are disclosed and described, it is to be understood that the terminology used herein is for the purpose of describing particular embodiments only and is not intended to be limiting. It must be noted that, as used in the specification and the appended claims, the singular forms “a,” “an” and “the” include plural references unless the context clearly dictates otherwise.

Throughout this application, where publications are referenced, the disclosures of these publications in their entireties are hereby incorporated by reference into this application in order to more fully describe the state of the art to which this invention pertains.

Those skilled in the art will be able to take the teachings herein and make variations or other embodiments which satisfy the same function and which fall within the scope of the claimed invention.

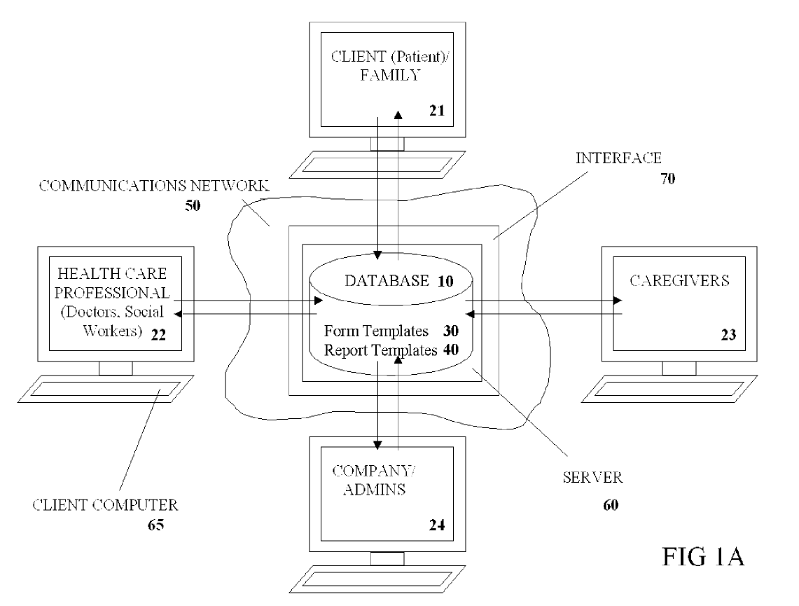

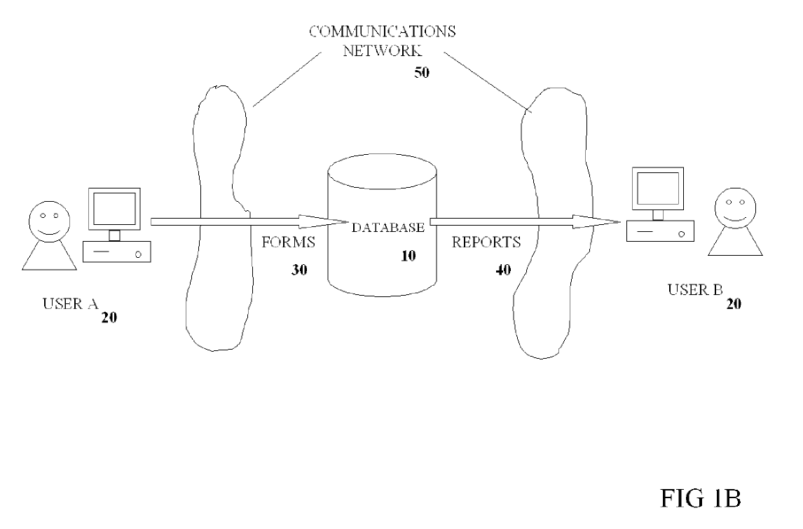

A preferred embodiment of the system of the present invention is illustrated in FIG. 1A and FIG. 1B. The system includes a database 10, or a site for the storage of data, residing in a server 60. The data server 60 may be any suitable platform including processing, memory, and data storage capability to perform the functions herein described, and that can be remotely accessed by client computers 21-24 through a secure electronic interface 70 on a communications network 50. The communications network 50 may include the Internet or another suitable private or public network. In this example, the system is a roles-based application in which different users are given different types of access to the database 10 via the interface 70. The interface 70 is preferably configured as a web page displayed within a web browser running on a suitable platform. The web server may be any suitable web server platform containing routines for displaying the web page and for managing online communication between a user 20 logged in via an associated web page and the data server 60. In addition, the system may also include security features that make it compliant with government regulations in dealing with sensitive medical information.

In the database, one or more forms 30 or report 40 templates are stored. The forms can be accessed by users 20 to input a plurality of information, which may include patients' medical background, patients' medication history, patients' care profiles, home care shift reports, patients' condition checklist, caregiver tentative schedules, client satisfaction surveys, a petty cash log, activity guides, a food menu calendar, and invoices. Other types of information input relating to home care services are also possible.

After the system receives the input from the forms 30 into its electronic tables, or other data storage tools, it processes and repackages, or sorts and assembles, the data into reports 40. In some embodiments, the system may extract client blood pressure data from patient condition checklists that have been inputted into the database. The system may then take the client blood pressure data and arrange them chronologically in a table format, with high and low levels of blood pressure highlighted in the reports 40. The system may also be triggered to send out email notifications when the numbers in the blood pressure data exceed a certain ceiling or threshold. The system may also convert the blood pressure data into a graph, such as a scatter plot, to make trends immediately recognizable. The system may also arrange the blood pressure data alongside data of meals eaten in the same time period taken from the food menu calendar so that system users 20 can see how certain foods affect the client's blood pressure.

Preferably, users 20 may use these reports 40 to identify and make a quick analysis of important trends. For example, a number of the elderly have hypertension, a condition that is made worse by salty food. If a client family member sees from the home care shift report that the caregiver allowed the client to eat potato chips, the client family member can contact the company administrators to notify the caregiver that there should be a change in diet.

In this embodiment, users 20 can log on to the system at any time to view the reports 40 that are available to them according to their User Class. The User Class determines the type of options, or access, and reports 40 available to the user. Examples of classes include: clients and client's family members 21, healthcare professionals 22 (which include doctors and social workers), caregiver 23, and company administrators 24. Other classes are also possible.

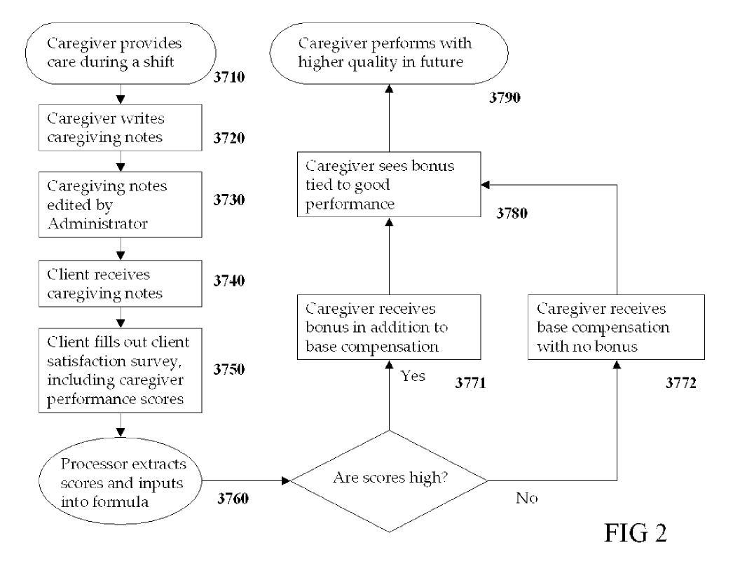

The system also includes a method of improving the quality of care from caregivers by providing daily incentives, compensation, bonuses, or rewards as illustrated in FIG. 2. In a preferred embodiment, after completing each shift 3710, the caregiver may use a client computer 65 to input caregiving notes 3720 into the database 10. After the administrator reviews and edits the notes 3730, the client family is invited to view the caregiving notes 3740, which may comprise one or more of the following: caregiver shift reports, patient condition data grids, caregiver observations, caregiver activity logs, food diary. The client family is then prompted to answer a client satisfaction survey 3750. In embodiments, these client satisfactions surveys may be sent out daily or weekly (or according to some other time interval) instead of after every shift. In addition, other embodiments contemplate sending surveys in conjunction with others tasks (e.g., after completing errands for the client). After viewing the completed survey, management may readjust or provide guidance to the caregiver on how to improve his/her future performance based on client comments in the client satisfaction survey. In addition to a space for written comments, the survey asks the client family to rate the caregiver for that particular shift based on a number scale 3750. The system processor takes that number rating, or caregiver performance score, from the inputted client satisfaction survey and plugs it into a mathematical formula to calculate caregiver compensation for that shift 3760. Caregiver compensation is a function of the length of the shifts and the caregiver performance scores. Caregivers that perform very well receive high scores that are matched to immediate daily reward bonuses 3771. In other embodiments, the reward bonuses can be weekly, monthly, or even yearly. Caregivers that do not perform well receive only the base compensation rate 3772. When caregivers begin to understand that good performance is rewarded 3780, they will then strive to improve the quality of their service 3790 if they desire the bonus.

The system may also include a method of tracking system usage, which allows company administrators to analyze where the system can be improved by determining how often each component of the system was used.

To setup the system, a company administrator may speak with the client's family or doctor and then may input client data 31, which may include the client's medical background, medication history, care profile, and other care information into the database 10 using a client computer 65, or other processing device, connected to the database server 60. The system may then repackage the input into classified reports 40 that may be viewed only by authorized users 20 to help them care for the client. This information may be changed or updated after a medical check-up.

The system also allows the company administrator to input or delete each user's login ID, password, and User Class into and from the database 10 using a system/user management form 39.

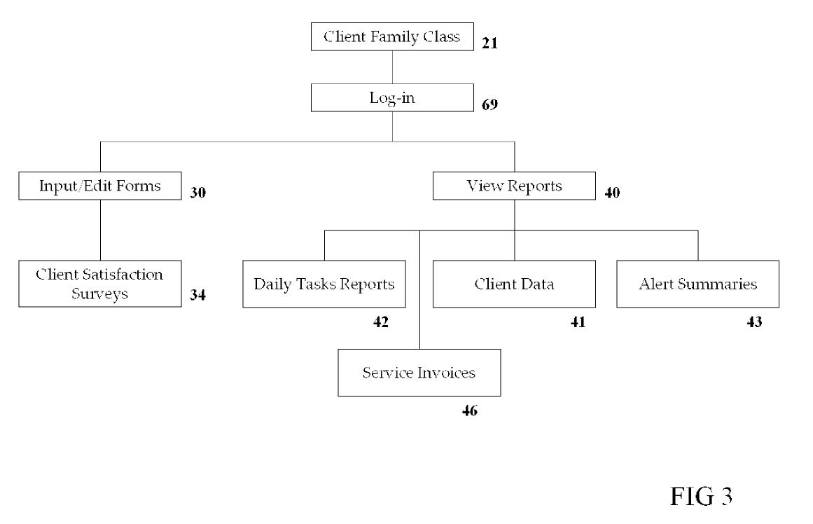

As illustrated in FIGS. 3 to 6, a user 20 can access the database 10 on any computer 65 connected to the communications network 50. The user 20 first goes to the communications network address where the system login page is located. In this embodiment, a system interface 70 will appear whereby the user can input their username and their password into the fields provided on the log-in page 69. The system then proceeds to verify that the information inputted is correct. After verification, the user is directed to a menu page with options that will vary depending on the User Class.

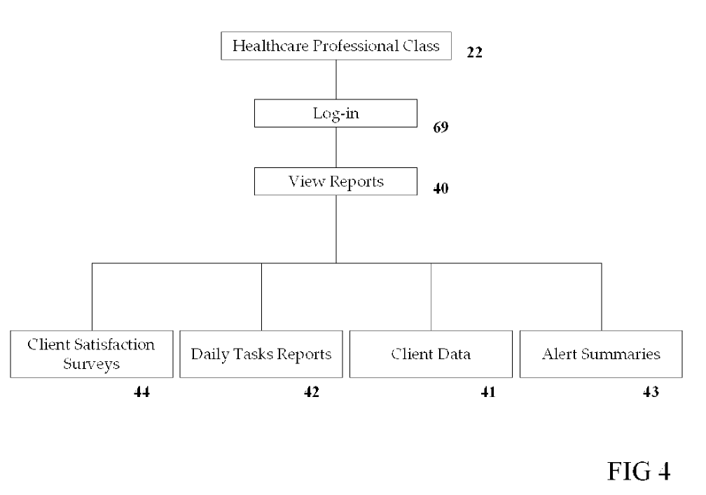

FIGS. 3 to 4 show a few possible distinctions between the Client Class user 21 and the Healthcare Professional Class user 22, in terms of the menu page. One is that the Healthcare Professional Class user 22 can potentially view the reports for more than one client. A second is that the Client Class 21 user has extra options of inputting caregiver performance scores through the client satisfaction survey form 34 and viewing service invoices 46. If the Client Class user 21 does not input caregiver performance scores, an Administrator Class user 24 has the ability to call the client and fill it in for them. Three options that may be shared by the Client Class 21 and the Healthcare Professional Class 22 are the viewing of alert summaries 43, the viewing of caregiving notes or daily tasks reports 42, and the viewing of client data 41. Alert summaries 43 allow client families and healthcare professionals know immediately when there has been a change in the client's health condition or medication. Daily tasks reports 42 may include different sub-reports documenting care activities and caregiver observations of client condition. If the user chooses to view client data 41, examples of reports that might be available include care instructions, medical background, and medication history.

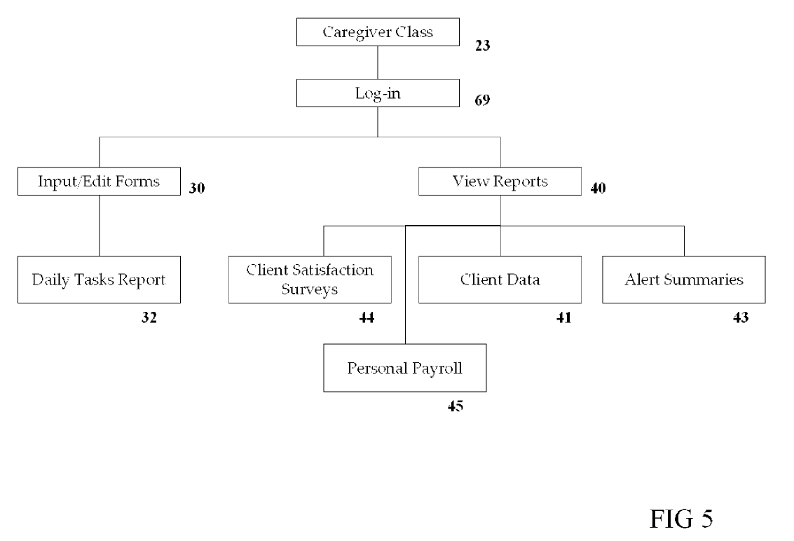

As illustrated in FIG. 5, the Caregiver Class 23 user may select from a number of options. For example, the Caregiver Class user may input or edit daily tasks report 32, view client data 41, or view their own performance scores in the client satisfaction surveys 44. The daily tasks report 32 can have, for example, many parts: a shift report, a patient condition checklist, a tentative activity schedule, a mileage record, an expense log, and a petty cash log. To input the new daily tasks report 32, the Caregiver Class user 23 selects the client name and inputs the day and time of the service. The Caregiver Class user 23 also inputs the home care activities into the shift report and the observations made of the patient into the patient condition checklist. In addition, the Caregiver Class user may also input their caregiving plan for the next week into the tentative activity schedule. Furthermore, the Caregiver Class user details the amount of money spent during caregiving activities by inputting dollar amounts into a petty cash log and expense record. A mileage record may also included so that company management can track how much travel time is incurred during a particular shift of caregiving. In one embodiment, the petty cash log, the expense record, and the mileage record may possibly feed into electronic service invoices and be a part of a cash control system used by management. After an Administrator Class user 24 approves the new daily tasks report, the system then sends a notification to a Client Class user 21 to log on to the system to check the report as well as to fill out a client satisfaction survey 34.

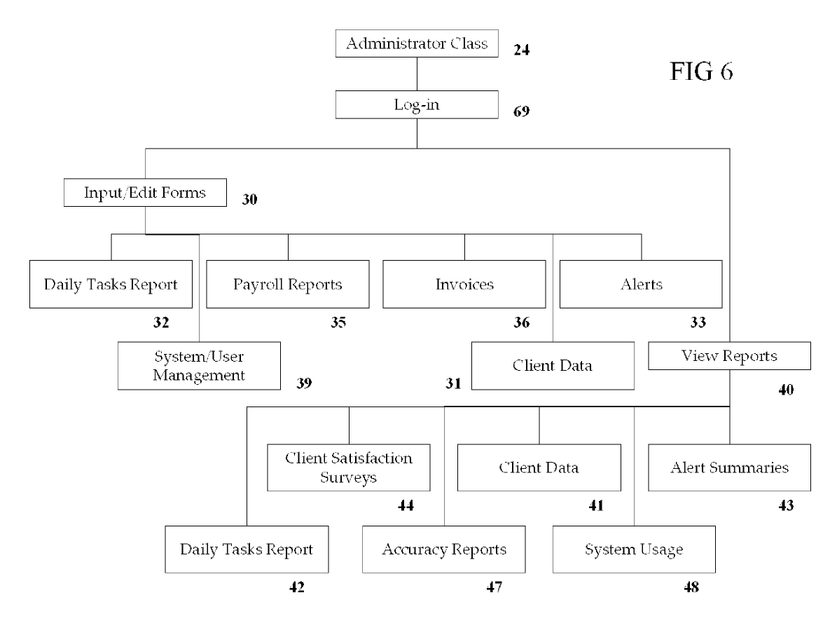

As illustrated in FIG. 6, the Administrator Class user 24 has numerous options. Not only may they input and view all client data 31 and 41, alert summaries 33 and 43, and all client satisfaction surveys 44, they may also manage user access 39, edit and view submitted daily tasks reports 32 and 42, edit payroll reports 35, edit invoices 36, view accuracy reports 47, and track system usage 48.

After a user finishes using the system, they may log off, which is made easy by clicking the log-off icon on the menu screen.

### CONCLUSION, RAMIFICATIONS, AND SCOPE

Accordingly, the reader will see that the method and system of this invention can be used to improve the quality and value of home care service by combining better coordination with a performance based compensation. Furthermore, embodiments of the present invention contemplate
improving transparency in an industry which traditionally did not keep detailed records of caregiving activities;
allowing all who are involved in caring for a client to share and be aware of the same information for improved coordination, so that critical info will be less likely to fall through the cracks;
providing incentives for caregivers to perform better by setting better daily performance equal to higher compensation;
providing accountability by documenting everything with details in forms that are viewable as reports;
providing simple-to-analyze reports that allow company management to be more efficient through managing by exception;
allowing healthcare professionals to track clients after discharge and to assure them that the care provided is satisfactory;
allowing doctors to know about any changes in medication or condition immediately;
improving ease of access to records by allowing access from remote locations;
improving security by keeping sensitive records in a central database compliant with government regulations; and
reducing paper waste and prevents record loss or damage.

Although the description above contains many specifics, these should not be construed as limiting the scope of the invention but as merely providing illustrations of some of the presently preferred embodiments of this invention.

Thus the scope of the invention should be determined by the appended claims and their legal equivalents, rather than by the examples given.

What is claimed is:

1. A computerized method of managing homecare services comprising: receiving in a database at least one variable relating to a user's access; providing at least one electronic form for inputting and storing in said database: client data, caregiving notes, caregiver performance data, and at least one user's system access profile; assembling said client data, said caregiving notes, and said caregiver performance data into one or more reports; reviewing and analyzing said one or more reports to determine areas of home care service in need of improvement; and analyzing said caregiver performance data to make at least one decision regarding the management of home care services.

2. The method according to claim 1 comprising:
providing access to said database to a user via a communications network browser.

3. The method according to claim 1 further comprising:
transmitting at least one e-mail notification when there is at least one change in the caregiving environment including client conditions and daily caregiving activities.

4. The method according to claim 1 further comprising:
allowing management to correct errors in caregiver inputs, and tracking system usage for maintaining and refining the usability of the system.

5. The method according to claim 1 wherein said client data includes:
at least one client's medical background,
at least one client's medication history, and
at least one client's profile and care information.

6. The method according to claim 1 wherein said caregiving notes includes:
at least one activity schedule,
at least one client condition data grid or checklist,
at least one caregiver's shift report, and
at least one food diary.

7. The method according to claim 1 wherein said caregiver performance data includes:
at least one caregiver performance score,
at least one client comment on caregiver performance, and
at least one company administrator comment on what the caregiver can do to improve.

8. The method according to claim 1 wherein said assembling client data includes:
analyzing the data,
identifying trends and patterns in the data, and
repackaging and sorting data into reports that reflect said trends and patterns.

9. The method according to claim 1 further comprising:
using said caregiver performance score to determine caregiver compensation.

10. The method according to claim 1 further comprising:
managing caregiving expenses with:
a cash control system,
mileage record,
expense reports, and
perpetual invoices.

11. A homecare services management system, comprising: a computerized unit configured to receive a plurality of variables relating to user access and provide and collect electronic forms submitted from users, said electronic forms including fields for inputting: client data, caregiving notes, caregiver performance data, and at least one user's system access profile; a database configured to store said electronic forms; a processor configured to: repackage said client data, said caregiving notes, and said caregiver performance data into one or more reports, and review and analyze said one or more reports to find exceptions to the norm that need management's attention; and said processor also configured to: extract caregiver performance scores from said caregiver performance data, and input said caregiver performance scores into a mathematical formula to determine caregiver compensation.

12. The system according to claim 11 further comprising:
an email notification system.

13. The system according to claim 11 further comprising:
a secure communications network-based interface interacting with said database.

14. The system according to claim 11 further comprising:
an editing tool for management to correct errors in caregiver inputs, and
usage trackers for maintaining and refining usability of said system.

15. The system according to claim 11 wherein said client data includes:
at least one client's medical background,
at least one client's medication history, and
at least one client's profile and care information.

16. The system according to claim 11 wherein said caregiving notes includes:
at least one activity schedule,
at least one client condition data grid or checklist,
at least one caregiver's shift report, and
at least one food diary.

17. The system according to claim 11 wherein said caregiver performance data includes:
at least one caregiver performance score rating,
at least one client comment on caregiver performance, and
at least one company administrator comment on what the caregiver can do to improve.

18. The system according to claim 11 further comprising:
managing caregiving expenses with:
a cash control system,
mileage record,
expense reports, and
perpetual invoices.

19. A computerized system for managing homecare services comprising: means for receiving in a database at least one variable relating to a user's access; means for providing at least one electronic form for inputting and storing in said database: client data, caregiving notes, caregiver performance data, and at least one user's system access profile; means for repackaging and sorting said client data, said caregiving notes, and said caregiver performance data into one or more reports; means for reviewing and analyzing said one or more reports to determine areas of home care service in need of improvement; and means for using said caregiver performance data to make at least one decision regarding the management of home care services.
